(19) United States
(12) Patent Application Publication
(10) Pub. No.: US 2026/0124610 A1
(43) Pub. Date: May 7, 2026

(54) METHOD FOR OPERATING A REACTOR, WHICH COMPRISES A CATALYST MATERIAL, FOR CATALYTICALLY STORING OR RELEASING HYDROGEN GAS, AND SYSTEM COMPRISING SUCH A REACTOR

(71) Applicant: HYDROGENIOUS LOHC TECHNOLOGIES GMBH, Erlangen (DE)

(72) Inventors: Alexander WEIß, Möhrendorf (DE); Alexander SEIDEL, Erlangen (DE); Alexander PFLÜGER, Oberasbach (DE); Caspar PAETZ, Erlangen (DE)

(21) Appl. No.: 19/118,495

(22) PCT Filed: Oct. 5, 2022
(86) PCT No.: PCT/EP2023/077573

§ 371 Date: Apr. 4, 2025

(30) Foreign Application Priority Data
Oct. 13, 2022 (DE) 10 2022 210 824.8

(51) Int. Cl. B01J 38/10; B01J 38/02; B01J 38/06; B01J 38/12; C01B 3/0015

(52) U.S. Cl. CPC B01J 38/10; B01J 38/02; B01J 38/06; B01J 38/12; C01B 3/0015

(57) ABSTRACT

A method for operating a reactor comprising a catalyst material having catalytically hydrogenating or catalytically dehydrogenating hydrogen carrier medium by contacting the catalyst material with the hydrogen carrier medium in the reactor, and flushing the catalyst material with a flushing medium into the reactor thereby removing catalyst-deactivating substances. The flushing medium comprises a hydrogen carrier medium.

### CROSS REFERENCE TO RELATED APPLICATIONS

This application is a United States National Phase Application of International Application PCT/EP 2023/077573, filed Oct. 5, 2023, and claims the benefit of priority under 35 U.S.C. § 119 of German Application 10 2022 210 824.8, filed Oct. 13, 2022, the entire contents of which are incorporated herein by reference.

### TECHNICAL FIELD

The invention relates to a method for operating a reactor, comprising a catalyst material, for catalytically storing or releasing hydrogen gas as well as to a system comprising such a reactor.

### BACKGROUND

DE 10 2015 219 305 A1 discloses a device for catalytically releasing hydrogen gas from a hydrogen carrier medium. The release reaction is a dehydrogenation reaction of the hydrogen carrier medium. The dehydrogenation is effected in a dehydrogenation reactor by means of a catalyst. Tests have shown that the activity of the catalyst decreases the more it is used. As a consequence of the loss of activity, the reactor power decreases. The volumetric and gravimetric power density during the hydrogen release are reduced. The technical performance of the reactor is decreased.

If a decreasing activity is established for the catalyst material, complex regeneration measures are required which can lead in particular to a temporary shutdown of the reactor. For regeneration purposes, an oxidative method can be used in order to regenerate the catalyst material. Increased safety measures are required owing to the use of oxygen. There is also a risk that oxygen-containing impurities are formed as a result of the oxidative regeneration, said impurities then having to be subsequently purified from the hydrogen carrier medium in a complex manner. The oxidative regeneration is complex and adversely affects the overall efficiency of the method.

It has been found that the deactivation of the catalyst material can be caused by deposits which can be degradation products of the hydrogen carrier medium. The formation of degradation products depends on the process control during the hydrogenation or dehydrogenation of the hydrogen carrier medium. An adaptation of the hydrogenation or dehydrogenation method such that the formation of degradation products is reduced or can be avoided is very complex.

### SUMMARY

It is an object of the invention to increase the service life of the catalyst material using simple methods.

This object is achieved in accordance with the invention by a method having the features set forth in the description.

The core of the invention is that catalyst-deactivating substances can be effectively flushed off from a catalyst material by means of a flushing medium. During flushing, the catalyst material can remain in a reactor which is used for catalytic hydrogenation or dehydrogenation of hydrogen carrier medium. Flushing is performed in a straightforward manner. In particular, the flushing medium is liquid. This improves flushing around the catalyst material and the removal of the catalyst-deactivating substances.

A catalyst-deactivating substance is in particular a coking and/or a coke precursor which are formed in particular during the catalytic hydrogenation or catalytic dehydrogenation of the hydrogen carrier medium in the reactor.

The catalyst-deactivating substances are in particular deposits, in particular aromatic and/or unsaturated molecules which are particularly large. In particular, large molecules according to this definition are planar, aromatic, Pi-conjugated hydrocarbon compounds with at least 16 carbon atoms and in particular at least 20 carbon atoms in the carbon skeleton. The catalyst-deactivating substances can be additionally or alternatively, in particular in dependence upon the degree of coking, completely graphitic carbon deposits on the catalyst material.

The catalyst-deactivating substances are deposited in particular on a surface of the catalyst material and/or on the catalytically active precious metal, so that the hydrogenation reaction and/or dehydrogenation reaction is inhibited.

It has been found that the method is suitable in a particularly advantageous manner for a hydrogen carrier medium. Hydrogen can be reversibly chemically bound to the hydrogen carrier medium and then released. In particular, such a hydrogen carrier medium is a liquid organic hydrogen carrier medium (LOHC). A hydrogen carrier medium which is present in a form, which is at least partially loaded with hydrogen, as perhydro-dibenzyltoluene (H18DBT), perhydro-benzyltoluene (H12BT), dicyclohexane and/or methylcyclohexane (C7H14), which can be dehydrogenated to form toluene (C7H8), has proven to be particularly suitable. It is also possible to use a mixture of hydrogen carrier medium in the form of perhydro-diphenylmethane and perhydro-biphenyl which are at least partially loaded with hydrogen. These compounds can be dehydrogenated to form diphenylmethane and biphenyl. A mixture of biphenyl to diphenylmethane in a ratio of 30:70, in particular 35:65 and in particular 40:60 is particularly advantageous.

The catalyst material has a metal, in particular platinum, palladium, nickel, rhodium, rhenium and/or ruthenium and in particular mixtures and/or alloys of these metals. In particular, the catalyst material is arranged on a catalyst carrier and, in particular, is fastened thereto. In particular, aluminium oxide, silicon oxide, titanium oxide, zirconium oxide and/or activated carbon are used as the catalyst carrier. In particular, the catalyst carrier is a porous oxidic carrier. The material of the catalyst carrier has pores with a diameter of at least 10 nm, in particular at least 20 nm, in particular at least 50 nm and in particular at least 100 nm. The weight proportion of the catalyst material in relation to the catalyst carrier is between 0.1% to 10%.

The catalyst carrier comprises a multiplicity of catalyst particles, in particular catalyst carrier particles which are present in particular as pellets. The catalyst particles have an average particle size of 0.5 mm to 10 mm, in particular of 1 mm to 8 mm and in particular of 2 mm to 4 mm.

The catalyst particles are arranged in particular in the form of a fixed bed, through which the hydrogen carrier medium, which is in particular at least partially liquid, flows. The hydrogen carrier medium can also be present at least in part as a vapor, in particular if benzyltoluene is used as the hydrogen carrier medium in the at least partially unloaded form. As a result of the vapor proportion of benzyltoluene in the dehydrogenation, coking can occur, in particular high-boiling point coking, which is not discharged in the gas phase. With increasing conversion in the dehydrogenation, the gaseous proportion of the hydrogen carrier medium increases because released hydrogen gas causes a partial pressure reduction in the hydrogen carrier medium.

It has been surprisingly found that by flushing the catalyst material, the initial activity of the catalyst can be restored at least partially and in particular to at least 50%, in particular to at least 70%, in particular to at least 80%, in particular to at least 90% and in particular to at least 95%. In particular, it has been found that as a result of flushing, the catalyst-deactivating substances are flushed off from the surface of the catalyst material and/or the catalytically active precious metal. The hydrogenation reaction and/or the dehydrogenation reaction can then be performed uninhibited after flushing. In particular, it has been recognized that complex regeneration measures for the catalyst material, in particular the oxidative regeneration, can be omitted or at least the extent of oxidative regeneration can be reduced.

A further finding in respect of the invention is based on the fact that a hydrogen carrier medium, in particular a further hydrogen carrier medium, serves as the flushing medium. In particular, non-system flushing media which differ systematically from the hydrogen carrier medium can be omitted. The flushing medium can be the hydrogen carrier medium which is catalytically hydrogenated and/or dehydrogenated. In particular, the hydrogen carrier medium used as a flushing medium can be identical to the hydrogenated or dehydrogenated hydrogen carrier medium. A hydrogen carrier medium with a comparatively low boiling point, such as e.g. toluene, facilitates the downstream removal of the catalyst-deactivating substances from the flushing medium and/or the hydrogen carrier medium because the catalyst-deactivating substances are high-boiling components. If the hydrogen carrier medium used as a flushing medium is itself a higher-boiling component, flushing can be effected around the catalyst material in an advantageous and sufficient manner, in particular at higher temperatures, because the liquid phase proportion in the higher-boiling hydrogen carrier medium as a flushing medium is increased compared to low-boiling flushing media. It is particularly advantageous if the flushing medium is at least partially charged hydrogen carrier medium, in particular benzyltoluene.

It has been found that at least partially loaded hydrogen carrier medium is particularly suitable as a flushing medium because the affinity of further deposits of degradation products, in particular coke deposits, on the catalyst material is reduced with the at least partially loaded hydrogen carrier medium. The risk of deposits of degradation products can be reduced in particular by releasing hydrogen gas during flushing. With reduced reaction conditions and/or reduced flushing conditions, the risk of coke formation is also reduced when using at least partially unloaded hydrogen carrier medium as the flushing medium.

Reduced reaction conditions mean in particular reduced reaction temperatures of at most 330° C., in particular at most 320° C., in particular at most 300° C. and in particular at most 280° C. The reduced temperatures result in smaller conversions and thus a reduced proportion of unloaded hydrogen carrier medium in the gas phase. It has been found that an increased gas phase content of the at least partially unloaded hydrogen carrier medium can cause undesired coking of the catalyst material. This risk is reduced at the reduced temperatures. As a result of the reduced temperatures, the thermal stress on the hydrogen carrier medium is also reduced.

The flushing conditions, in particular the efficiency for detaching coke deposits from the catalyst surface, is increased when at least partially unloaded hydrogen carrier medium is used as the flushing medium. Like the at least partially unloaded hydrogen carrier medium, the coke deposits are aromatic hydrocarbons. As a result, the solubility is increased. Therefore, it has been recognized as being particularly advantageous that by using hydrogen carrier medium as the flushing medium, the flushing conditions can be adapted virtually continuously during the flushing process. The adaptation of the flushing conditions is advantageously possible by virtue of the fact that either at least partially loaded hydrogen carrier medium, i.e. reactant, or at least partially unloaded hydrogen carrier medium, i.e. product, or a mixture of product and reactant which has been adjusted in particular with a specific mixing ratio is used as the flushing medium. An advantageous adaptation of the flushing conditions is additionally or alternatively also possible by recirculating product from a hydrogenation reactor or dehydrogenation reactor as reactant into this reactor, i.e. circulating the flushing medium. This allows the degree of hydrogenation of the flushing medium to be changed in a targeted and, in particular, continuous manner during the flushing procedure.

Flushing out the catalyst-deactivating substances with the at least partially loaded hydrogen carrier medium is possible in an improved manner.

A hydrogen carrier medium is understood to be loaded if the degree of hydrogenation is at least 80%, in particular at least 90%, in particular at least 95% and in particular at least 99%.

In particular, the flushing medium has the at least partially loaded hydrogen carrier medium. The proportion of the at least partially loaded hydrogen carrier medium in the flushing medium is at least 50%, in particular at least 70%, in particular at least 90%, in particular at least 95% and in particular at least 99%. In particular, the flushing medium consists exclusively of the at least partially loaded hydrogen carrier medium.

The flushing of the catalyst material can be easily incorporated into the operation of the reactor. In particular, the flushing can be integrated as an integral part of a method cycle. Complex retrofitting measures can be omitted.

A method in which the flushing medium is fed in co-flow to the hydrogen carrier medium through the reactor simplifies the performance of flushing. Alternatively, it is possible to feed the flushing medium in counter-flow to the hydrogen carrier medium, which is to be hydrogenated or dehydrogenated, through the reactor.

The process in accordance with the invention is suitable for flushing catalyst material which is used for hydrogenation and/or dehydrogenation of hydrogen carrier medium.

It has been found that less and in particular no catalyst-deactivating coking is formed during hydrogenation compared to dehydrogenation. Flushing of the catalyst material by circulating the flushing material is particularly advantageous during hydrogenation. In particular, the outlay required for adapting the pressure and/or temperature is reduced because the liquid phase proportion of the flushing medium in the hydrogenation reaction is sufficiently high. The basic mechanisms for performing the flushing procedure, i.e. an increase in pressure, a decrease in temperature and/or an increase in the mass flow of the flushing medium, can aid efficient flushing.

A method permits targeted influencing of the flushing properties and thus of the reactivation of the catalyst material. It has been found that the flushing properties change in dependence upon the material properties of the flushing medium, in particular its physiochemical properties and in particular the degree of hydrogenation of the further hydrogen carrier medium which serves as the flushing medium. In particular, changed flushing properties can be established in a targeted manner.

In particular, it has been recognized that the flushing properties, in particular the degree of hydrogenation of the further hydrogen carrier medium, can be adjusted in a targeted manner before and/or during a flushing procedure. This improves the influence on the flushing properties.

It has been recognized that at least partially unloaded hydrogen carrier medium comprising aromatic hydrogen carriers has improved solubility for the coking which typically has a similar molecular structure to the at least partially unloaded hydrogen carrier medium.

At least partially loaded hydrogen carrier medium as a flushing medium has saturated hydrogen carriers, so that the separation of coking from the flushing medium in a downstream purification process is facilitated by reason of the different molecular structures.

A method simplifies a switch between catalytic hydrogenation or catalytic dehydrogenation of the hydrogen carrier medium and flushing of the catalyst material.

In particular, so-called dynamic flushing can be effected. The process conditions in the reactor are comparable during the catalytic hydrogenation or catalytic dehydrogenation and flushing. The process conditions required in each case can be adapted in an uncomplicated and in particular rapid manner. It has been shown that the catalyst material can be flushed at a flushing temperature between 100° C. and 350° C., in particular between 150° C. and 330° C. and in particular between 200° C. and 300° C. A flushing pressure for the dehydrogenation is in particular between 0.5 barg and 6.0 barg, in particular between 0.8 barg and 5.5 barg and in particular between 1.0 barg and 5.0 barg. The flushing pressure for the hydrogenation is in particular between 0.5 barg and 50 barg, in particular between 5 barg and 40 barg and in particular between 10 barg and 30 barg.

In particular, it has been recognized that the flushing pressures for the hydrogenation can be different, wherein the flushing pressure for the hydrogenation is greater than the flushing pressure for the dehydrogenation.

The dehydrogenation is effected at process temperatures between 280° C. and 330° C. and at a pressure between 0.5 barg and 5.0 barg.

The hydrogenation is effected at process temperatures between 200° C. and 350° C. and at a pressure between 10 barg and 50 barg.

In particular, it has been found that the flushing can be started directly from catalytic hydrogenation or catalytic dehydrogenation, wherein further process-engineering adaptations can be omitted. Switching between catalytic hydrogenation or catalytic dehydrogenation and flushing is effected in particular by adapting the pressure, i.e. from a hydrogenation pressure or dehydrogenation pressure to the flushing pressure. In particular, the hydrogenation pressure or dehydrogenation pressure is increased to the flushing pressure and so, in relation to the catalytic dehydrogenation method, the changed chemical state of equilibrium results in a reduced release of hydrogen. The reduced hydrogen release rate shifts the process equilibrium of the hydrogen carrier medium between the vapor proportion and the liquid proportion towards the liquid proportion. This means that the liquid proportion of the hydrogen carrier medium increases which aids the flushing of liquid around the catalyst material.

In particular, it is possible that at least small amounts of hydrogen gas can be released even during flushing. In relation to a nominal operating point of a dehydrogenation method, the release rate of the hydrogen during flushing can be at least 5%, in particular at least 10%, in particular at least 20%, in particular at least 30% and in particular up to 50%. The lower the release rate during flushing, the lower the vapor proportion and the more efficient the flushing.

In particular, it has been found that it is possible to switch between a catalytic hydrogenation or dehydrogenation method and flushing based on the hydrogen gas pressure in the reactor. Using the hydrogen gas pressure, dynamic control between the hydrogenation or dehydrogenation method and the flushing method is possible, in particular by adapting the reaction pressure in the reactor accordingly. In addition or alternatively, dynamic control is also possible by means of the reaction temperature in order to switch between the hydrogenation or dehydrogenation method and the flushing method. In particular, a reduction in the reaction temperature can render it possible to switch from the hydrogenation method or dehydrogenation method to the flushing method.

Flushing can be initiated in particular in dependence upon the hydrogen consumption at a hydrogen consumer. If the hydrogen consumption at the hydrogen consumer is less than a defined threshold value, a flushing procedure can be initiated preventively, in particular in order to avoid a situation where a flushing procedure at a later point in time results in a restriction of the hydrogen gas release rate and the hydrogen consumer cannot be supplied with sufficient hydrogen gas. In particular, it is thereby possible to start a flushing procedure at an early stage with regard to the increasing catalyst deactivation. It is particularly advantageous if the hydrogen released to a reduced extent during flushing meets the demand of the hydrogen consumer, wherein the hydrogen consumer requires in particular at most 30% of the hydrogen release rate in relation to a nominal operating point, in particular at most 20%, in particular at most 10% and in particular at most 5%.

The initiation of flushing can also be determined on the basis of the changed volume flow of hydrogen gas in a defined time interval. The change in the volume flow relates in particular to a stationary, specific operating point of the system. It is understood that the absolute volume flows can differ depending upon the configuration of the respective system. The lower the amount of stored hydrogen gas released per time interval, the greater the relative deactivation of the catalyst material. It is possible to define limit values or tolerance ranges which trigger the initiation of flushing. For example, flushing can be initiated if the hydrogen release capacity is reduced by a maximum of 0.5%/h, in particular a maximum of 0.1%/h, in particular a maximum of 0.01%/h and in particular a maximum of 0.001%/h.

Alternatively, a limit value or tolerance range can also be taken into account for the amount of hydrogen carrier medium or hydrogen gas used in relation to the catalyst material. This consideration is independent of the reaction time. By reason of the non-linear relationship between concentration and reaction rate, a non-linear decrease in hydrogen storage or hydrogen release can be observed when the rate constant decreases constantly. The decrease in the hydrogen storage or hydrogen release increases accordingly when the rate constant decreases constantly over time. Exceeding a defined limit value can be used in order to initiate flushing. During hydrogenation and/or dehydrogenation, the flushing can be initiated in particular if a relative hydrogen storage capacity decreases by 5% per kg (H2)/kg (catalyst), in particular at most 1%, in particular at most 0.1%. In relation to the amount of hydrogen carrier medium used, flushing is initiated if the relative storage capacity decreases by 1% per kg (hydrogen carrier medium)/kg (catalyst material), in particular 0.1% and in particular 0.01%.

A comparison of a current hydrogen storage capacity or hydrogen release capacity in relation to an initial level of the respective capacity can also serve to initiate flushing. In particular, flushing is initiated as soon as the current capacity value is less than 80% of the initial value.

Flushing can also be initiated when the storage of hydrogen or the release of hydrogen within a stationary operating point reaches or is less than a previously defined deactivation limit. In general, the deactivation limit can be related to a time interval, to a specific capacity of the catalyst and/or the hydrogen carrier medium or to relative limit values in dependence upon a nominal capacity point. A reduction in the relative hydrogen capacity of at least 10%, in particular at least 1.0%, in particular at least 0.1% and in particular at least 0.01% can be taken into account in relation to the initial capacity.

A method simplifies a direct transition of the various process steps, in particular a flexible switch from catalytic hydrogenation or catalytic dehydrogenation to flushing of the catalyst material.

A method permits targeted flushing of the catalyst material. In particular, the flushing is effected on the basis of measured values which indicate imminent deactivation and/or deactivation of the catalyst material already under way. On the one hand, this ensures that flushing is effected in good time, in particular before the catalyst material is insufficiently deactivated. On the other hand, it is guaranteed that flushing is effected only when this is also required. The outlay for unnecessary flushing procedures is reduced.

A method can be advantageously integrated into a process sequence, in particular an automated one.

A method permits the direct reuse of the flushing medium, in particular as the hydrogen carrier medium. In particular, cleaning of the flushing medium can be performed on site, i.e. at the location of the system where the reactor is located. Cleaning can also be performed in a spatially separated manner, in particular at another location. A cleaning unit used for cleaning is particularly favoured, if the flushing medium is at least partially loaded hydrogen carrier medium. Since the catalyst-deactivating substances to be removed are aromatic, cleaning is favoured by reason of different physiochemical properties if the flushing medium has at least a proportion of saturated hydrocarbons and in particular consists exclusively of saturated hydrocarbons.

Spatially separated and separate cleaning of the flushing medium is particularly advantageous when the flushing medium is heavily contaminated. As the proportion of by-products in the flushing material increases and/or with a longer flushing duration and correspondingly higher amount of contaminated flushing material, the outlay for the flushing method on site increases. A spatially separated, in particular central purification unit, to which in particular a plurality of reactors can be connected and/or which can be supplied with contaminated flushing material from a plurality of reactors, is then particularly efficient in relation to purification performance. Such cleaning is economically efficient. The economic efficiency is particularly advantageous if a proportion of contaminations in the flushing medium is at least 0.2%, in particular at least 0.5%, in particular at least 1%, in particular at least 3%, in particular at least 5%, in particular at least 10%, in particular at least 15% and in particular at least 20%.

The cleaning unit can be combined both with a dehydrogenation reactor and a hydrogenation reactor. A cleaning unit comprising a corresponding sensor system upstream of the reactor, i.e. before the inlet to the reactor, is particularly preferred. Any catalyst-deactivating substances which have remained and are guided in particular from the dehydrogenation method to the hydrogenation method can thus be removed from the fluid flow.

A method permits an at least temporary continuation of reactor operation during flushing. It has been recognized that the reactor can also be operated at least at reduced power during flushing. In particular, the relative hydrogen gas release or storage rate is at most 80% in relation to nominal operation, in particular at most 75% and in particular at most 70%. The nominal load is a defined capacity, at which a system can be operated at a stationary standard operating point. The nominal load is established in particular in a system-specific manner. For example, a nominal load point of a dehydrogenation system can mean a release capacity of 1 kg (H2)/h. In a flushing operation, in the case of a reduction of the release capacity by 50%, there is a release of 0.5 kg (H2 )/h accordingly.

A method permits an average capacity corresponding to a nominal capacity of 100%. It has been recognized that during regular operation of the system, a capacity above the nominal capacity can be established, in particular of at least 102% of the nominal capacity, in particular at least 105% and in particular at most 110%. This comparatively minor exceeding of the nominal capacity is not a problem for the system. In particular, the system is designed for slightly exceeding the nominal capacity. In particular, continuous operation in this capacity range does not result in damage to the infrastructure, especially the reactor. Damage to the hydrogen carrier medium can also be precluded. By operating the system at increased capacity during hydrogenation or dehydrogenation, regular flushing cycles can be performed at reduced capacity, wherein the average or effective capacity then always corresponds to the nominal capacity. Regular flushing does not result in the nominal load being impaired.

A method permits an increase in the degree of activity of the catalyst material. It has been recognized that the effectiveness of a flushing procedure is limited. During oxidative regeneration, organic residues on the catalyst material are burnt off in order to achieve a higher reactivation. In particular, during oxidative regeneration no or at most small amounts of contaminated hydrogen carrier medium are produced.

In particular, it has been recognized that hydrogen in the dehydrogenation reactor can have an advantageous effect with regard to catalyst regeneration. Hydrogen can be released e.g. during flushing by reason of the dehydrogenation activity of the flushing medium. In addition or alternatively, hydrogen can be added separately. The presence of hydrogen reduces the formation of coke on the catalyst material. The presence of hydrogen also assists the regeneration of already coked catalyst material. It has also been found that superelevated reaction temperatures can be avoided by adding hydrogen separately. These increased reaction temperatures would be necessary if the dehydrogenation was performed with catalyst material which is at least partially deactivated because it is coked. The elevated temperatures would result in an increased vapor proportion of the unloaded hydrogen carrier medium and have a disadvantageous effect on the catalyst stability. These problems are solved by adding hydrogen gas.

In addition or alternatively, flushing with water vapor is possible.

A system has essentially the advantages of the method.

A system permits uncomplicated provision of the flushing medium. It is advantageous if the system has a plurality of storage containers which store the flushing medium, i.e. the further hydrogen carrier medium, in dependence upon the degree of hydrogenation. For this purpose, it is advantageous if the degree of hydrogenation of the hydrogen carrier medium is measured or determined by means of a measuring unit. The degree of hydrogenation-dependent storage of the flushing medium allows the degree of hydrogenation of the flushing medium to be changed during flushing, i.e. in particular the dehydrogenation of the flushing medium during the flushing procedure. Alternatively, it is possible to guide the flushing medium into one or a plurality of storage containers irrespective of the actual degree of hydrogenation and to mix it at this location. The measuring of the degree of hydrogenation of hydrogen carrier medium is described e.g. in EP 3 218 711 B1.

In particular, a recirculating line guarantees a continuous flow of flushing medium over the catalyst material. In particular, fresh flushing medium can be admixed flexibly and in particular in dependence upon an amount of contamination caused by catalyst-deactivating substances. Contaminated flushing medium can be removed from the circuit.

Alternatively, flushing medium can flow over the catalyst material as a through-flow in the reactor. The contaminated flushing medium which is discharged from the reactor and carries in particular the catalyst-deactivating substances, can be fed to a separate cleaning unit where it is cleaned. In this variant, it is ensured that fresh, i.e. unused, flushing medium is always available. The efficiency of the flushing procedure is increased.

A system extends the possibilities, in particular in respect of performing the method in an automated manner.

A system permits early detection of the deactivation of the catalyst material.

A system permits the reuse of the flushing medium.

Both the features stated in the description and the features stated in the exemplified embodiments of a system in accordance with the invention are each suitable, either individually or in combination with one another, for developing the subject matter in accordance with the invention. The respective combinations of features do not constitute any restriction with regard to the developments of the subject matter of the invention, but instead have essentially merely exemplary character.

The various features of novelty which characterize the invention are pointed out with particularity in the features annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a system in accordance with the invention;

FIG. 2 is a schematic view of the functional relationship of a hydrogen gas release rate in the system shown in FIG. 1 in dependence upon the time of day in a first operating mode; and

FIG. 3 is a view, corresponding to FIG. 2, in a second operating mode.

### DESCRIPTION OF PREFERRED EMBODIMENTS

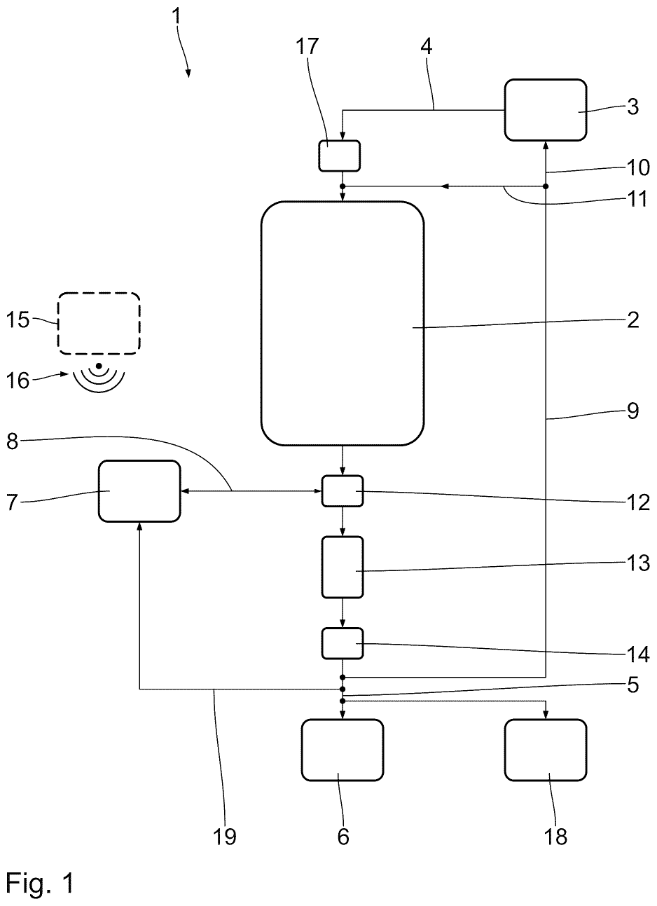

Referring to the drawings, a system designated overall by 1 in FIG. 1 is used for the catalytic storage or release of hydrogen gas by means of a hydrogen carrier medium.

The system 1 has a reactor 2 which, according to the exemplified embodiment shown, is designed as a dehydrogenation reactor. The reactor 2 can also be designed as a hydrogenation reactor.

A catalyst material, not illustrated in greater detail, is arranged in the reactor 2 and is contacted with the hydrogen carrier medium for catalytic dehydrogenation.

A first storage container 3 is connected to the reactor 2 via a feed line 4. Hydrogen carrier medium can be fed into the reactor 2 from the first storage container 3 via the feed line 4. The first storage container 3 stores in particular at least partially loaded and in particular fully loaded hydrogen carrier medium.

A discharge line 5 is connected to the reactor 2 and issues into a second storage container 6. The second storage container 6 stores hydrogen carrier medium which has reacted catalytically in the reactor 2, i.e. has been catalytically dehydrogenated. At least partially unloaded hydrogen carrier medium is stored in the second storage container 6.

The use of two separate storage containers 3, 6 allows the hydrogen carrier medium to be stored in dependence upon the degree of hydrogenation thereof. More than two storage containers can also be used in order to separately store intermediate stages of the hydrogen carrier medium, i.e. with different degrees of hydrogenation. It is also possible to use only one storage container in which the at least partially loaded and the at least partially unloaded hydrogen carrier medium are stored together, in particular are mixed.

The system 1 has a third storage container 7 which is used for storing flushing medium. The flushing medium storage container 7 is fluidically connected in a bi-directional manner to the discharge line 5 by means of a branch line 8.

The use of the third storage container 7 is particularly advantageous when the hydrogen carrier medium used as the flushing medium is fundamentally different from the hydrogen carrier medium to be dehydrogenated in the reactor 2 and/or when the purification of the flushing medium is to be performed in a decoupled manner, in particular outside the system 1, in particular at a remote location and/or when the flushing medium is not to be mixed with the hydrogen carrier medium as reactant or product.

However, it is also possible for the flushing medium to be of the same type and in particular identical to the hydrogen carrier medium to be dehydrogenated. In this case, it is particularly advantageous if separate storage containers can be dispensed with. In particular, it is sufficient to have a single storage container in which the at least partially loaded and at least partially unloaded hydrogen carrier medium and the corresponding flushing medium of the same type are stored.

In principle, it is also feasible to use separate storage containers for fresh and used flushing medium. If hydrogen carrier medium is used as a flushing medium, the first storage container 3 can be used as a flushing medium storage container. The flushing medium storage container 7 then serves as a storage container for contaminated flushing medium, i.e. used flushing medium, which is removed from the hydrogen carrier medium circuit.

Also connected to the discharge line 5 is a recirculating line 9 which issues with a first recirculating line branch 10 into the first storage container 3 and issues with a second recirculating line branch 11 into the feed line 4 and/or directly into the reactor 2.

A first sensor unit 12, a cleaning unit 13 and a second sensor unit 14 are arranged on the discharge line 5 along the fluid flow direction. The recirculating line 9 branches off from the discharge line 5 in a region between the second sensor unit 14 and the second storage container 6. The flushing medium storage container 7 is connected in particular in a direct manner to the first sensor unit 12 by means of the branch line 8.

The first sensor unit 12 is used to detect a proportion of catalyst-deactivating substances in the flushing medium. According to the exemplified embodiment shown, the first sensor unit is designed in particular as an optical analysis unit, in particular a photometer, as an infrared spectrometer, as a Raman spectrometer or as a fluorescence spectrometer. It has been recognised that the substances flushed down from the catalyst material cause a discolouration of the transparent, colourless flushing medium. In particular, the substances cause a yellowish to reddish discolouration of the flushing medium. The flushed substances can be detected by detecting this discolouration, in particular in an automated manner.

The first sensor unit 12 is in signal communication with a control/regulating unit 15 which is indicated in FIG. 1 by the symbol 16 as a wireless signal connection. The signal communication can also be effected in a wired manner.

In order to evaluate the measurement result determined by the first sensor unit 12, a reference sensor unit 17 is arranged upstream of the reactor 2, in particular along the feed line 4. In particular, the reference sensor unit 17 is designed identically to the first sensor unit 12. The reference sensor unit 17 can be used to measure the discolouration of the, in particular unused, flushing medium. On the basis of a relative discolouration of the flushing medium, the contamination of the flushing agent can be detected and, in particular, calculated from a comparison of the measured data from the first sensor unit 12 and the reference sensor unit 17.

The control/regulating unit 15 is in signal communication in particular with the reactor 2 in order to adapt e.g. the reaction conditions in the reactor 2, in particular the reaction pressure. The control/regulating unit 15 outputs in particular a control signal in order to initiate the flushing process. When the pressure is increased, the amount of hydrogen released during dehydrogenation is not discharged from the reactor 2, or at least is done so only to a reduced extent, which results in the pressure increase in the reactor 2. This reduces the hydrogen release rate in the reactor. The generation of the pressure increase can be accelerated by virtue of the fact that hydrogen gas at a sufficient pressure level is guided back into the reactor 2 from a hydrogen gas buffer in order to increase the pressure in the reactor 2.

In addition or alternatively, it is possible to reduce the reaction temperature, in particular by reducing a heating unit provided for the reactor 2. Since the dehydrogenation reaction is effected in an endothermic manner, the reactor 2 cools down at least partially and in particular automatically if no and in particular insufficient external heat is fed thereto. The mass flows of the flushing medium during the flushing procedure can be influenced in a targeted manner via a hydrogen carrier medium feed pump and/or separate pumps installed for the flushing procedure.

According to the exemplified embodiment shown, the cleaning unit 13 is designed as an activated carbon adsorber. In the cleaning unit 13, the catalyst-deactivating substances are separated from the flushing agent, in particular in an adsorptive manner. The state of the flushing medium can be detected by means of the second sensor unit which is arranged downstream of the cleaning unit 13 and in particular is designed identically to the first sensor unit 12. In particular, the concentration of the contaminating substances in the flushing medium is detected. In particular, the second sensor unit 14 is in signal communication with the control/regulating unit 15.

The measurement result detected by means of the second sensor unit 14 serves on the one hand as a basis for determining whether the flushing agent can then be fed via the recirculating line 9 in the first storage container 3 and/or to the reactor 2. However, the measurement result also provides information regarding the state of the cleaning unit 13 and in particular the adsorption capacity of the cleaning unit 13.

A method for operating the reactor 2 is explained in greater detail hereinafter. Loaded hydrogen carrier medium is fed from the first storage container 3 via the feed line 4 to the reactor 2 where it is dehydrogenated, i.e. hydrogen gas is released from the hydrogen carrier medium. The hydrogen gas is released by the hydrogen carrier medium contacting a catalyst material present in the reactor 2.

A mixture of at least partially unloaded hydrogen carrier medium and released hydrogen gas is discharged from the reactor 2 via the discharge line 5. The at least partially unloaded hydrogen carrier medium is stored in the second storage container 6 and can be reprocessed, i.e. loaded with hydrogen, e.g. by renewed hydrogenation.

It is advantageous if the mixture consisting of unloaded hydrogen carrier medium and hydrogen gas are separated from one another in a separation unit, not shown in greater detail. This improves the storage of the at least partially unloaded hydrogen carrier medium in the second storage container 6. The released hydrogen gas can be utilised in a hydrogen consumer 18, in particular a fuel cell, which is illustrated purely schematically. It is advantageous if the hydrogen consumer 18 is in signal communication with the control/regulating unit 15.

Hydrogen carrier medium which has been discharged from the reactor 2 but is at least partially, i.e. sufficiently, loaded, can then be fed to the reactor 2 via the recirculating line 9 for renewed dehydrogenation or can be stored in the first storage container 3.

During operation of the reactor 2, catalyst-deactivating substances, particularly in the form of aromatic compounds, especially coking, can form on the catalyst material. These substances cause a deactivation of the catalyst material and thus a restriction to the reactor capacity.

A decrease in the reactor capacity can be detected e.g. by means of the control/regulating unit 15, in that e.g. volume flows of the hydrogen gas released in the reactor 2 and discharged from the reactor 2 are detected per unit of time. If the value is less than a definable threshold value, a flushing method can be initiated in order to flush the catalyst-deactivating substances from the catalyst material. In order to perform the flushing, flushing medium is fed from the flushing medium storage container 7 to the reactor 2 via the discharge line 5, the recirculating line 9 and the second recirculating line branch 11. In particular, the flushing medium is a hydrogen carrier medium. In a particularly preferred embodiment, the flushing medium is a low-boiling hydrogen carrier medium, such as e.g. methylcyclohexane or toluene. In particular, the feeding of the hydrogen carrier medium used for dehydrogenation is terminated during flushing and resumed only after the end of the flushing procedure. However, since the flushing medium is a hydrogen carrier medium which is suitable basically for dehydrogenation in the reactor 2, it is not necessary to separate the material flows with regard to dehydrogenation on the one hand and flushing on the other hand. In particular, switching from dehydrogenation to flushing is effected directly by increasing the pressure in the reactor 2.

The advantages of the dynamic switching of individual operating modes and the unnecessary separating of flushing medium and hydrogen carrier medium are advantageous particularly when using hydrogen carrier medium as the flushing medium which is of the same type as or is identical to the hydrogen carrier medium to be dehydrogenated, in particular benzyltoluene. The basic control/regulating mechanisms are similar when using dissimilar types of hydrogen carrier media as flushing media and, in particular, dissimilar types of flushing media. However, in order to prevent mixing between the flushing medium and the hydrogen carrier medium, separate fluid circuits are advantageous, in particular the separation of contaminated flushing medium in a separate flushing medium storage container.

The flushing medium which is discharged from the reactor 2 and contains the flushed-out catalyst-deactivating substances, is analysed by the first sensor unit 12, i.e. the proportion of catalyst-deactivating substances is measured, in particular by comparison with the reference measurement in the reference sensor unit 17. For this purpose, it can be advantageous if the flushing medium from the flushing medium storage tank 7 is guided via a separate line through the reference sensor unit 17 before the flushing medium is passed to the reactor 2. In addition or alternatively, a sensor, not illustrated, for measuring the catalyst-deactivating substances could be arranged along the recirculating line 9.

The duration of flushing can be time-controlled. Flushing can also be terminated in particular if the proportion of catalyst-deactivating substances in the flushing medium is reduced and in particular no catalyst-deactivating substances are measured. The reduction in these substances can be detected by means of the first sensor unit 12.

A dynamic switch back from the flushing mode to the dehydrogenating mode is dynamically possible, in particular controlled by the control/regulating unit 15. The flushing medium containing the contaminating substances is cleaned in the cleaning unit 13 and the cleaning progress is detected by the second sensor unit 14. In particular, when the flushing cycle is terminated, the flushing medium cleaned in the cleaning unit 13 is then recirculated to the flushing medium storage container 7 via a flushing medium storage line 19.

A high-boiling hydrogen carrier medium, in particular dibenzyltoluene or perhydro-dibenzyltoluene, can also be used as the flushing medium. It has been found that cleaning of the flushing medium in the cleaning unit 13 is simplified. In addition, the liquid phase proportion of the flushing medium in the reactor 2 can be increased in an uncomplicated manner.

It is advantageous if the cleaning unit 13 is regenerated, in particular at regular intervals and/or in dependence upon the measurement result which is detected by the second sensor unit 14. The cleaning unit 13 can be regenerated, in particular by back-flushing, and so in particular the activated carbon adsorber can then be released.

Therefore, it is particularly advantageous if the system 1 comprises at least two cleaning units 13 which are arranged in particular in parallel with one another in the fluid flow. This makes it possible to regenerate one of the cleaning units 13 and simultaneously use the at least one other cleaning unit 13 to clean the flushing medium. Non-operation time of the system by reason of the necessary regeneration of the cleaning unit 13 is thereby avoided. The overall efficiency of the method is thereby increased.

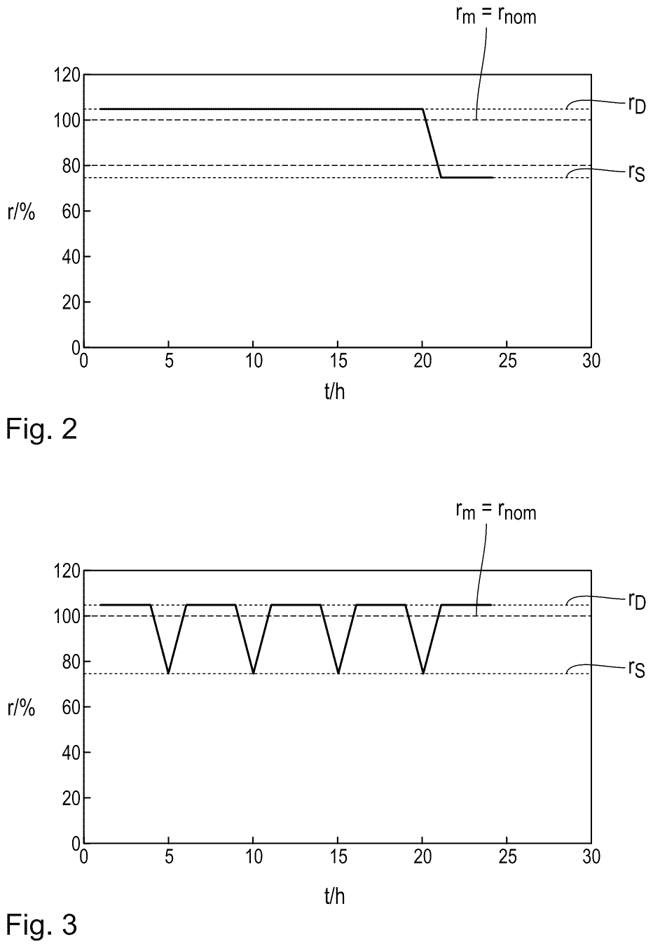

As illustrated in FIG. 2, it is advantageous if the reactor 2 is operated at a hydrogen gas release rate r(t) of greater than 100%. According to the exemplified embodiment shown, the hydrogen gas release rate during the dehydrogenation operation r_{D} is 105%. The release rate during the dehydrogenation operation is thus 5% above the nominal release rate rₙₒₘ of 100% and thus above the nominal capacity of the dehydrogenation reactor. It is also apparent from FIG. 2 that flushing is effected at the end of a working day, i.e. approximately after twenty hours of operating time of the reactor 2. During the flushing operation, the hydrogen gas release rate rₛ is about 75%. By virtue of the fact that the hydrogen gas release rate during the dehydrogenation operation r_{D} is above the nominal hydrogen gas release rate rₙₒₘ, an average hydrogen gas release rate rₘ is exactly the nominal hydrogen gas release rate rₙₒₘ of the dehydrogenation reactor 2.

FIG. 3 shows an alternative operating mode in which a plurality of flushing cycles take place over the course of a working day. According to the exemplified embodiment shown, four flushing cycles take place, in particular regularly every five hours. As in the previous example, during the flushing operation the hydrogen gas release rate rₛ is temporarily reduced to about 75% in relation to the nominal hydrogen gas release rate rₙₒₘ. By virtue of the fact that, during the regular dehydrogenation operation, the hydrogen gas release rate r_{D} is above the nominal hydrogen gas release rate rₙₒₘ, in particular at 105%, this results in the average hydrogen gas release rate rₘ corresponding to the nominal hydrogen gas release rate rₙₒₘ of the dehydrogenation reactor 2.

While specific embodiments of the invention have been shown and described in detail to illustrate the application of the principles of the invention, it will be understood that the invention may be embodied otherwise without departing from such principles.

1. A method for operating a reactor comprising a catalyst material, the method comprising the method steps of:
catalytically hydrogenating or catalytically dehydrogenating hydrogen carrier medium by contacting the catalyst material with the hydrogen carrier medium in the reactor, and
flushing the catalyst material with a flushing medium in the reactor and thereby removing catalyst-deactivating substances, wherein the flushing medium comprises a hydrogen carrier medium, wherein the flushing comprises an increase in pressure, a decrease in temperature and/or an increase in the mass flow of the flushing medium.

2. A method according to claim 1, wherein that flushing properties are established in a specifically variable manner in dependence upon material properties of the flushing medium.

3. A method according to claim 1, wherein during flushing in the reactor, there is present a flushing temperature between 100° C. and 350° C. and/or a flushing pressure for dehydrogenation between 0.5 barg and 6.0 barg.

4. A method according to claim 1, wherein the flushing is effected in a hydrogen atmosphere, wherein the proportion of hydrogen gas at total pressure is at least 10%.

5. A method according to claim 1, wherein the flushing is performed in a manner controlled by means of a control/regulating unit.

6. A method according to claim 1, wherein the flushing is performed in a routine manner.

7. A method according to claim 1, wherein the flushing medium having the catalyst-deactivating substances is cleaned in a cleaning unit, wherein the cleaning unit is configured as an adsorption unit, as a distillation unit and/or as a cleaning unit having a separating membrane.

8. A method according to claim 1, wherein in that the flushing is effected during a low-capacity phase of the reactor.

9. A method according to claim 1, wherein the catalytic hydrogenation or the catalytic dehydrogenation is effected in a capacity range above the nominal load.

10. A method according to claim 1, wherein oxidative regeneration and/or flushing with hydrogen gas and/or flushing with water vapor is effected after the flushing.

11. A system for catalytically storing or releasing hydrogen gas from a hydrogen carrier medium, the system comprising:
a reactor for catalytically hydrogenating or for catalytically dehydrogenating the hydrogen carrier medium by contacting it with catalyst material,
a flushing medium feed for feeding a flushing medium into the reactor, and
a control/regulating unit for performing the flushing in a regulated manner according to a method comprising the steps of:
catalytically hydrogenating or catalytically dehydrogenating hydrogen carrier medium by contacting the catalyst material with the hydrogen carrier medium in the reactor, wherein
flushing the catalyst material with a flushing medium in the reactor and thereby removing catalyst-deactivating substances, wherein the flushing medium comprises a hydrogen carrier medium, wherein the flushing comprises an increase in pressure, a decrease in temperature and/or an increase in the mass flow of the flushing medium.

12. A system according to claim 11, wherein a recirculating line for recirculating hydrogen carrier medium from the reactor as flushing medium into the reactor, wherein a storage container is connected to the recirculating line.

13. (canceled)

14. A system according to claim 11, wherein at least one sensor unit for detecting a proportion of catalyst-deactivating substances in the flushing medium, wherein the sensor unit is configured as a photometer and/or as a fluorescence spectrometer and is arranged outside the reactor.

15. A system according to claim 11, wherein a cleaning unit for cleaning the flushing medium having the catalyst-deactivating substances.

16. A method according to claim 1, wherein that flushing properties are established in a specifically variable manner in dependence upon physiochemical properties of the flushing medium.

17. A method according to claim 3, wherein during flushing in the reactor, there is present a flushing temperature between between 150° C. and 330° C., and/or a flushing pressure for dehydrogenation between 0.8 barg and 5.5 barg.

18. A method according to claim 4, wherein the proportion of hydrogen gas at total pressure is at least 50%.

19. A method according to claim 4, wherein the proportion of hydrogen gas at total pressure is at least 90%.

20. A method according to claim 5, wherein the flushing is performed in a manner controlled by means of a control/regulating unit, in dependence upon the catalyst activity and/or in dependence upon the hydrogen consumption at a hydrogen consumer.

21. A method according to claim 6, wherein the flushing is performed in a routine manner, wherein the routine manner is a fixed cycle on multiple occasions every working day and/or at the beginning or at the end of a working day.
